(19) United States
(12) Patent Application Publication
(10) Pub. No.: US 2018/0265423 A1
(43) Pub. Date: Sep. 20, 2018

(54) Pesticide Dispersion in Concentrated Aqueous Fertilizer Solution

(71) Applicant: Akzo Nobel Chemicals International B.V., Arnhem (NL)

(72) Inventors: Shawn Zhu, Stormville, NY (US); Joshua Lewis Jurs, New Fairfield, CT (US); Michael Walters, Rhinebeck, NY (US)

(21) Appl. No.: 15/532,610

(22) PCT Filed: Dec. 2, 2015
(86) PCT No.: PCT/EP2015/078322

§ 371 Date: Jun. 2, 2017

Related U.S. Application Data
(60) Provisional application No. 62/087,559, filed on Dec. 4, 2014.

(30) Foreign Application Priority Data
Feb. 17, 2015 (EP) 15155306.2

(51) Int. Cl. C05G 3/02; C05B 7/00

(52) U.S. Cl. CPC C05G 3/02; A01N 43/653; A01N 2300/00; C05B 7/00

(57) ABSTRACT

The invention is directed to a pesticide suspension composition including an aqueous fertilizer solution and a solid pesticide, wherein the composition includes from about 5 to about 70 wt % fertilizer and from about 0.1 to about 60 wt % pesticide based on the total composition, wherein the pesticide is a non-dissociating compound, and wherein the fertilizer concentration is selected to achieve a composition having a stable suspension of pesticide.

### BACKGROUND OF THE INVENTION

Application of a pesticide formulation to crops typically involves dilution of the pesticide formulation into water in a spray tank followed by spraying the pressurized solution through a nozzle by an applicator. The applicator commonly adds more agrochemicals such as compatibility agents, defoamers, water conditioning agents, or even another pesticide formulation to the spray tank to save a trip or two. In some applications specific pesticide formulations are mixed with a concentrated fertilizer solution and the resulting formula, which is typically about 1% pesticide, is applied to the targeted surfaces directly without further dilution with water. Similarly, more agrochemicals can be added by the applicator to this pesticide/fertilizer formulation at tank side.

One application of this is in seed planting where a machine is able to, in one pass, plough open a furrow, drop a grain of seed (or seeds) from a seed container, apply a small dose of an aqueous fertilizer containing pesticide (and possibly other agro chemicals) to the soil close to or on top of the seed (or seeds), and close the furrow to bury the seed (or seeds). The fertilizer used in this application is typically called a starter fertilizer such as 10-34-0 (˜56% ammonium polyphosphate). The pesticide used in this application typically is an insecticide and/or a fungicide. This application is becoming more and more popular because the starter fertilizer with pesticides can provide not only protection to the seeds by keeping the worms and fungi away but also provide the necessary initial boosting nutrients to the young plant, rendering the expensive and complicated seed coating/treatment process unnecessary. This application has been proven to render higher crop yields.

When the pesticide active is a solid, it can be conventionally formulated into various formulations such as a wettable powder (WP), suspension concentrate (SC), water dispersible granule (WDG) when the pesticide does not dissolve in water after dilution, water soluble granule (WSG) when the pesticide dissolves in water after dilution, suspo-emulsion (SE), emulsifiable concentrate (EC) when it can be dissolved in a solvent, or oil dispersion (OD). However, there are drawbacks to using each of these formulations. A WP formulation may not be desirable because a powder formulation presents potential inhalation hazard while handling the powder. WDG or WSG formulations may not be desirable because they require high processing cost, may present dust issues, and may take a long time to disperse in a liquid medium. An SE formulation may not be desirable because it is very difficult to prepare into a stable formulation and it requires a lot of development effort. An EC formulation may not be desirable because it requires a solvent which is usually associated with potential health or environmental issues. An OD formulation may not be desirable because it is difficult to prepare a stable formulation and it requires emulsifiers for the oil. An SC formulation has become a desirable choice for many formulators in recent years due to its environmental benefit because the suspension does not require solvents in the formulation. However, SC formulations that contain a solid pesticide with a low solubility in water typically require a dispersant, a wetting agent, a suspension aid, an anti-freeze, and an antimicrobial preservative. The concentrations of the dispersants, wetting agents, suspension aids, and anti-freeze agents in SC formulations are typically about 0.5-2%, 2-5%, 0.3-0.7%, and 5-10%, respectively. Dispersants are generally negatively charged molecules. It is believed the dispersants adsorb onto the particle surface and provide charge repulsion between dispersed solid particles to stabilize the formulation. Suspension aids are generally water soluble polymers that provide thickening and steric hindering to stabilize the formulation. It is believed that in most conventional SC formulations it is necessary to have both charge repulsion and steric hindering to produce stable suspensions. The anti-freeze in a SC formulation typically is a polyol, such as glycerine or a glycol.

Although dispersants, wetting agents, suspension aids, anti-freeze agents, and preservatives are considered necessary in preparing stable pesticide SC formulations, they are non-essential ingredients to crops or soil because they are not pesticides or fertilizers. Some of these ingredients also adversely affect the germination and sprouting of seeds. Also they may be less desired from an ecological point of view, especially if they bioaccumulate or would not be degradable. Therefore, it would be beneficial to reduce or eliminate the use of dispersants, wetting agents, suspension aids, anti-freeze agents, and preservatives in pesticide SC formulations.

In addition, to preparing an ready-to-spray SC formulation containing both fertilizer and pesticide at tank side just prior to application, it would be beneficial to combine a more concentrated fertilizer and pesticide formulation that can be stored, transported and merely diluted just prior to use. Such concentrated formulations have been disclosed, however they have drawbacks, generally requiring significant amounts of non-essential ingredients to maintain stability of the formulations.

U.S. Pat. No. 3,236,627 discloses an emulsion composition comprising a concentrated aqueous fertilizer, a water-immiscible oleaginous phase comprising an organic solvent solution, a pesticide and a dispersant with the following structure:

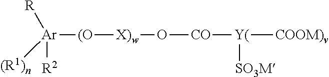

which is an organic substituted ammonium di-salt of a sulfosuccinic acid ester of an ethylene oxide adduct of an alkyl phenol. The emulsion composition was prepared at tank side by adding an emulsifiable concentrate (the water-immiscible oleaginous phase) into a concentrated fertilizer. The composition was stable for a few hours and it was intended to be applied during this period. However, the composition requires an organic solvent, as well as a dispersant.

U.S. Pat. No. 3,317,305 discloses a phosphate ester emulsifier as a means of providing stable emulsions of various biocides in liquid fertilizer compositions containing high concentration of electrolytes and/or other nutrient materials such as urea. The composition was prepared at tank side by adding an emulsifiable concentrate (the readily remulsifiable composition) into a concentrated fertilizer. The composition was reported as being stable (stable after 24 hours in one example). However, the composition requires an organic solvent and an emulsifier.

U.S. Pat. No. 4,382,013 discloses an emulsion composition prepared by adding into a concentrate fertilizer an emulsifiable concentrate (EC) comprising a solvent, biocide, and surfactant composition comprising an anionic emulsifier and a polyoxyalkylene glycol ester. The composition is intended for tank side application. It passed the emulsion stability test (no visible separation after 15 minutes) after mixing the EC and the fertilizer. The composition was reported as being stable (stable after 24 hours in one example). However, the composition requires an organic solvent and emulsifiers.

U.S. Pat. No. 4,313,847 discloses an emulsifiable concentrate requiring an organic solvent.

U.S. Pat. No. 4,464,193 discloses emulsions of liquid biocides in liquid fertilizers.

U.S. Pat. No. 8,029,827B2 discloses an insecticide SC composition stable for use in preparations of insecticidal liquid fertilizers. The composition comprises water, a pyrethroid (bifenthrin), a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester. The composition is intended to mix with a concentrated fertilizer at tank side. In the tank, the liquid fertilizer is preferably present in a concentration of from 95% to 99.99% by weight based upon the total weight of all components in the formulation. After mixing with 10-34-0 fertilizer at 1 wt % ai, the stability with the SC diluted to 10-34-0 was higher than the stability with a bifenthrin emulsifiable concentrate diluted to 10-34-0. However, the composition requires a hydrated aluminum-magnesium silicate and at least one dispersant. In addition, in all examples, a significant amount of propylene glycol was used as anti-freeze.

US 20120004103A1 discloses an insecticidal fertilizer composition comprising a) a bifenthrin; b) a hydrated aluminum-magnesium silicate; c) at least one dispersant selected from the group consisting of a sucrose ester, a lignosulfonate, an alkylpolyglycoside, a naphthalenesulfonic acid formaldehyde condensate and a phosphate ester; and d) a liquid fertilizer. However, the composition requires a hydrated aluminum-magnesium silicate and at least one dispersant. In addition, in all examples, a significant amount of propylene glycol was used as anti-freeze.

US2013/109725 discloses compositions of pesticide granules in a water soluble agglomeration suppressants.

It is an object of the present invention to prepare stable pesticide SC formulations in a liquid fertilizer medium with minimized or no use of dispersants, wetting agents, suspension aids, anti-freeze agents, and preservatives.

It is another object of the invention to prepare stable pesticide SC formulations in a concentrated liquid fertilizer medium with minimized or no use of dispersants, wetting agents, suspension aids, anti-freeze agents, and preservatives that remains stable when diluted in concentrated fertilizer solutions to application concentrations.

### SUMMARY OF THE INVENTION

The present invention is directed to a pesticide suspension comprising at least one solid pesticide and an aqueous fertilizer solution that meets the above objectives. In an embodiment of the invention, the solid pesticide does not have any carboxylic functional group (C—COOH). In an embodiment the pesticide has low solubility in the aqueous fertilizer solution, such that at least part pesticide does not dissolve in said fertilizer solution. In an embodiment the pesticide formulation remains stable, and the pesticide does not have crystal growth or form co-crystals with the fertilizer in the formulation.

A pesticide compound with a carboxylic functional group is a dissociating compound which is capable of dissociating into C—COO⁻ and H⁺ ions in water. Pesticide compounds without any carboxylate group are defined as non-dissociating compounds. A non-dissociating pesticide compound has a solubility in water of less than 1 percent by weight (wt %), or less than 0.5 wt %, or less than 0.2 wt %, or preferably less than 0.1 wt % at 20° C., based on the total weight of the pesticide and water. As used herein, “low solubility” also means a solubility in water of less than 1 percent by weight (wt %), or less than 0.5 wt %, or less than 0.2 wt %, or preferably less than 0.1 wt % at 20° C.

A typical fertilizer salt contains anions such as sulphate, phosphate and nitrate and cations such as ammonium and potassium. A fertilizer concentrate may have a concentration in the range from about 30 to about 70 wt % and it can be considered as a high electrolyte system. In high electrolyte systems, many agrochemicals that may be added tank side cannot be mixed with the aqueous fertilizer due to compatibility issues (with the concentrated fertilizer) that result in the system coagulating or separating into multiple-phases. The concentrated fertilizer solution also generally has very high surface tension and the liquid droplet does not wet on hydrophobic, high organic matter soil or on waxy, hydrophobic leaf surfaces causing the fertilizer to run off when applied. That is, spraying a concentrated fertilizer generally encounters compatibility and wetting issues. Additives are generally used to improve compatibility and wetting performance of an aqueous solution. However, it is not possible to predict which additive is suitable to serve as a compatibility aid or a wetting agent in concentrated fertilizer systems.

In one aspect, the present invention is directed to a method of improving the stability of a pesticide suspension by using a density matching method. According to this method, the density of the concentrated fertilizer solution is adjusted to match the density (or apparent density) of the pesticide by adjusting the concentration of the fertilizer (in the fertilizer SC solution), so that the pesticide is in a stable suspension in the fertilizer solution.

In one aspect of the invention, the invention is directed to a pesticide suspension composition comprising an aqueous fertilizer solution and a solid pesticide, wherein the composition comprises from about 5 to about 70 wt % fertilizer (for the active fertilizer) and from about 0.1 to about 60 wt % pesticide (for the active pesticide), or about 2.5 to 55 wt %. or about 5 to 50 wt % pesticide based on the total composition, wherein the pesticide is a non-dissociating compound, and wherein the fertilizer concentration is selected to achieve a composition having a stable suspension of pesticide. In one embodiment, the pesticide suspension composition is capable of being dispersed into a second aqueous fertilizer solution in an amount to achieve at least 1 wt % pesticide active, based on the total resulting formulation, and remain stable without forming crystals or coagulation for at least 2 hours. In one embodiment, the second aqueous fertilizer solution is 10-34-0 liquid fertilizer.

In one aspect of the invention, the fertilizer concentration is selected to provide a density of the aqueous fertilizer (D_{AF}) that matches the apparent density of the pesticide (D_{P}) at operating temperature. By apparent density is meant the tendency of the pesticide to rise or sink in a volume of the formulation relative to the other components. For example, if the apparent density of the pesticide is lower than the density of the aqueous fertilizer solution, the pesticide will tend to rise toward the surface of the solution, and if the apparent density of the pesticide is higher than the density of the aqueous fertilizer solution, the pesticide will tend to sink to the bottom of the aqueous solution. If the density of the aqueous fertilizer solution and apparent density of the pesticide are matched, the pesticide will be at or very close to neutral buoyancy in the aqueous solution. In embodiments of the invention, the operating temperature is the average temperature that the composition is stored at or the average temperature that the composition will be used (e.g., applied to crops). In embodiments, the operating temperature is in the range from about 0° C. to about 38° C., or about 4° C. to about 27° C., or about 10° C. to about 20° C.

In one aspect of the invention, the density of the aqueous fertilizer (D_{AF}) is selected to achieve a composition having a stable suspension of pesticide in the absence of dispersants, wetting agents, and suspension aids in the case of solid pesticides that are wettable by the aqueous fertilizer solution; or to achieve a composition having a stable suspension of pesticide in the absence of dispersants and suspension aids, and in the presence of an amount of wetting agent necessary for the aqueous fertilizer solution to wet the surface of the solid pesticide in the case of pesticides that are not wettable by the aqueous fertilizer solution. In an embodiment of the invention, the density of the aqueous fertilizer solution is (without other additives) at least 1.15, or at least 1.20, or at least 1.25, or at least 1.3, or at least 1.35, or at least 1.4, or at least 1.45, or at least 1.50 g/ml at 20° C.

In one embodiment, the pesticide suspension composition is substantially free of or free of any added dispersants, wetting agents, suspension aids, antifoams, and preservatives. With regard to such additives, substantially free means less than 5 wt %, less than 2 wt %, less than 1 wt %, less than 0.5 wt %, or less than 0.1 wt %, or less than 0.01 wt %, based on the total weight of the pesticide SC. In one embodiment, the pesticide suspension composition is substantially free of or free of any added dispersants and suspension aids. In one embodiment, the pesticide suspension composition further comprises a wetting agent.

In one embodiment, the fertilizer is a starter fertilizer. In one embodiment, the fertilizer is a starter fertilizer and the pesticide is chosen from an insecticide, a fungicide, or a mixture thereof. In one embodiment, the starter fertilizer is 10-34-0 fertilizer. In one embodiment, the fertilizer is 10-34-0 fertilizer and the pesticide is an insecticide, a fungicide, or a mixture thereof.

In embodiments of the invention, one or more pesticides can be pre-suspended in water or in a pre-suspension fertilizer solution and then combined with a second fertilizer solution to arrive at the pesticide suspension composition of the present invention. In one embodiment, the pre-suspension fertilizer solution can be the same as the second fertilizer solution. In other embodiments, the pre-suspension fertilizer solution and the second fertilizer solution are different. By different solutions means the pre-suspension fertilizer solution contains different types and/or different concentrations of fertilizers than the second fertilizer solution. For example, although they may contain one or more of the same fertilizer, the combinations and/or concentrations may not be identical.

In embodiments, the pre-suspension fertilizer solution has a different concentration of the same fertilizer or different concentrations of one or more fertilizers that are common to the fertilizers contained in the second fertilizer solution. In embodiments, the pre-suspension fertilizer solution can contain a different fertilizer, or one or more additional or fewer fertilizers than are contained in the second fertilizer solution.

In embodiments of the invention, the pesticide composition (as described herein) further comprises one or more additives selected from dispersants, wetting agents, suspension aids and combination thereof. As the composition can be formulated as a concentrated fertilizer/pesticide composition and then diluted prior to application on crops or as a started fertilizer at the time of seeding, the stability of the pesticide can be affected by changing the concentration and density of the aqueous fertilizer solution. By including additives, the composition can have increased latitude to allow it to remain stable with the pesticide remaining dispersed over a wider range of conditions. In embodiments of the invention, the additives are included in small amounts or with amounts limited to the amount necessary to provide the required stability. In embodiments, the additive(s) can be selected and added in amounts to selectively modify or adjust the density of the fertilizer solution, the apparent density of the solid pesticide or both.

In embodiments where the pesticide suspension composition is prepared from a pre-suspended pesticide, that is combined with a second fertilizer suspension, one or more additives (as described herein) can be included in the pre-suspension, in the second fertilizer solution, or in both.

In one embodiment, the pesticide suspension composition is substantially free of or free of any added anti-freeze agents.

In an aspect of the invention, it is directed to a method for preparing a stable pesticide suspension composition, the suspension comprising an aqueous fertilizer solution and a solid pesticide. The method comprises adjusting the fertilizer concentration to provide an aqueous fertilizer density (D_{AF}) that sufficiently matches the apparent density of the solid pesticide (D_{P}) to achieve a composition having a stable suspension of pesticide, and combining the aqueous fertilizer solution and solid pesticide to provide the stable pesticide suspension composition. In one embodiment, the D_{P} and D_{AF} can be determined and adjusted simultaneously by preparing sample formulations with varying concentrations of the fertilizer solution and evaluating the stability of the formulation.

In one embodiment, the method further comprises determining if the solid pesticide is wettable by the aqueous fertilizer solution and, if the pesticide is not wettable, adding a wetting agent to the composition of a type and in an amount sufficient for the aqueous fertilizer solution to wet the solid pesticide.

In another aspect, the invention is directed to a method of seeding a field, the method comprising applying a dose of the pesticide suspension composition (as described herein) to soil close to or on top of a seed (or seeds). In one embodiment, the fertilizer is a starter fertilizer. In one embodiment, the fertilizer is a starter fertilizer and the pesticide is chosen from an insecticide, a fungicide, or a mixture thereof. In one embodiment, the starter fertilizer is 10-34-0 fertilizer. In one embodiment, the fertilizer is 10-34-0 fertilizer and the pesticide is an insecticide, a fungicide, or a mixture of them.

In yet another aspect, the invention is directed to use of the pesticide suspension composition (as described herein) as a fertilizer having pesticide activity for crops.

### DETAILED DESCRIPTION OF THE INVENTION

The present invention is directed to a pesticide suspension comprising at least one solid pesticide and an aqueous fertilizer solution. In embodiments of the invention, the solid pesticide are non-dissociating compounds having low solubility in the aqueous fertilizer solution and the pesticide does not have crystal growth or form co-crystals with the fertilizer in the formulation. In embodiments of the invention, the solubility of the pesticide in the aqueous fertilizer solution is less than 1 percent by weight (wt %), or less than 0.5 wt %, or less than 0.2 wt %, or preferably less than 0.1 wt % at 20° C., based on the total weight of the pesticide and aqueous fertilizer solution. In embodiments of the invention, the melting point of the pesticide is higher than 50° C., or higher than 60° C., or higher than 70° C. In one aspect, the present invention is directed to a method for improving the stability of the pesticide suspension by using a density matching method.

In embodiments of the invention, the solid pesticide has an average particle size of less than 100 microns, or less than 50 microns, or less than 20 microns, or preferably less than 10 microns, as measured by known techniques, such as by a dynamic light scattering (DLS) technique. The methods for reducing particle size of pesticide materials are well known to those skilled in the art.

In one embodiment, the pesticide is formulated with a concentrated liquid fertilizer. In embodiments having a concentrated liquid fertilizer, the concentration of the solid pesticide in the pesticide suspension is in the range from about 10 to about 60 wt %, or from about 15 to about 55 wt %, or from about 20 to about 50 wt %, or preferably from about 25 to about 45 wt %, based on the total composition.

In another embodiment, the pesticide suspension is formulated with a liquid fertilizer having a concentration that can be applied without further dilution at tank side by an applicator. In embodiments for a ready to use pesticide composition, the concentration of the solid pesticide is in the range from about 0.1 to about 10 wt %, or from about 0.5 to about 5 wt %, or preferably from about 1 to about 2 wt %, based on the total composition.

In one aspect of the invention, a novel pesticide suspension in concentrated liquid fertilizer as the medium without or with only a small amount of additives is provided. The pesticide suspension can be combined with a second concentrated fertilizer solution such as a 10-34-0 fertilizer and can be diluted in water easily with only gentle mixing. Farmers can then apply the diluted pesticide suspension using special equipment. The diluted suspension can be diluted so that the pesticide concentration is in accordance with the ready to use composition (discussed above).

Fertilizer included in the present invention is a material that is added to the soil, aqueous growing medium, or sprayed on a leaf to supply one or more elements required for plant growth and productiveness, or to enhance pesticide activities. The major three elements are nitrogen, potassium and phosphorus, and the secondary elements, also called micronutrients, are calcium, sulfur, magnesium, as well as boron, manganese, iron, zinc, copper, silicone, and molybdenum. Fertilizers enhance the natural fertility of the soil or replace the chemical elements taken from the soil by harvesting, grazing, leaching or erosion. Artificial fertilizers are typically inorganic fertilizers formulated in appropriate concentrations and combinations to supply three main nutrients: nitrogen, phosphorus and potassium (N, P and K) for various crops and growing conditions. N (nitrogen) promotes leaf growth and forms proteins and chlorophyll. P (phosphorus) contributes to root, flower and fruit development. K (potassium) contributes to stem and root growth and the synthesis of proteins. The common inorganic fertilizers include ammonia (82% nitrogen), NPK combinations, urea (46% nitrogen), superphosphate, mono and dibasic ammonium phosphates (containing nitrogen and phosphate), calcium ammonium nitrate, potassium chloride (muriate of potash). The N-P-K content of typical fertilizers is listed below in table 1.

TABLE 1
N—P—K content of typical fertilizers.

Nutrient wt %

| Fertilizer | N | P₂O₅ | K₂O |
|---|---|---|---|
| Ammonia anhydrous | 82 | | |
| Ammonia solution | 20-25 | | |
| Ammonium Bicarbonate | 15.5 | | |
| Ammonium Chloride | 25-27 | | |
| Ammonium Phosphate sulfate | 13-16 | 20-39 | |
| Ammonium Polyphosphate (10-34-0) | 10-11 | 34-37 | |
| Ammonium Thiosulfate | 12 | | |
| Ammonium Chloride | 25-26 | | |
| Ammonium Nitrate | 33-34 | | |
| Ammonium Sulfate | 21 | | |
| Ammonium Sulfate Nitrate | 26 | | |
| Calcium Ammonium Nitrate | 20-28 | | |
| Calcium Cyanamide | 20-21 | | |
| Calcium Nitrate | 15 | | |
| Diammonium Phosphate | 18-21 | 46-54 | |
| Dicalcium phosphate | | 35-52 | |
| Kainit | | | 12-22 |
| Monoammonium Phosphate | 11 | 48-55 | |
| Nitrogen Solution | 28-41 | | |
| Phosphate Rock | | 26-37 | |
| Potassium Chloride | | | 60 |
| Potassium Magnesium Sulfate | | | 22 |
| Potassium Nitrate | 13 | | 44 |
| Potassium Sulfate | | | 50 |
| Slag Basic | | 12-18 | |
| Slag Potassic | | | 43 |
| Superphosphate single | | 17-20 | |
| Superphosphate triple | | 44-48 | |
| Sodium Nitrate | 16 | | |
| Urea Phosphate | 17 | 43-44 | |
| Urea | 45 | | |
| Urea Ammonium Nitrate | 28-32 | | |
| Urea Ammonium Phosphate | 21-38 | 13-42 | |
| Urea Sulfate | 30-40 | | |

In embodiments of the invention, the aqueous fertilizer solution contains soluble salts of fertilizers. Urea, a fertilizer for plants, is not a salt but it may also be present in the aqueous fertilizer solution of the present invention. In one embodiment, the fertilizer is chosen from ammonium polyphosphate, ammonium sulphate, ammonium nitrate, ammonium bicarbonate, ammonium carbonate, ammonium chloride, potassium chloride, potassium sulphate, potassium polyphosphate, potassium carbonate, potassium bicarbonate or combinations thereof. In one embodiment, the fertilizer solution contains 10-34-0 (N as total nitrogen and P as P₂O₅, 56% solid), URAN 32 (˜80% solid with ˜45% ammonia nitrogen and ˜34.8% urea in ˜20% water), URAN 28, 28-38% ammonium sulphate, 21-21-21 (N as nitrate/ammonia, P as P₂O₅, and K as K₂O), 13-27-27 (N as nitrate/ammonia, P as P₂O₅, and K as K₂O), 27-4-0, or combinations thereof. In an embodiment, the fertilizer solution further comprises a small amount of micronutrients.

In one embodiment, the fertilizer solution contains a starter fertilizer. In one embodiment, the starter fertilizer is 10-34-0. In one embodiment, the fertilizer solution is 10-34-0 (N-P-K) liquid fertilizer which is about 56% ammonium polyphosphate (and may contains a small amount of micronutrients such as Zn⁺²) with a density of about 1.40 g/ml at room temperature.

In embodiments of the invention, the concentration of active fertilizer in the suspension concentrate is at least about 10 wt %, or at least about 15 wt %, or at least about 20 wt %, or at least about 25 wt % and up to about 70 wt %. In embodiments of the invention, the freezing point of the fertilizer solution without the solid pesticide is below 0° C., or below −10° C., or below −15° C., or below −20° C.

In embodiments of the invention, the pesticide SC comprises micronutrients. In one embodiment, the micronutrients are included in the aqueous fertilizer solution. In one embodiment, the micronutrients are chosen from calcium, sulfur, magnesium, boron, manganese, iron, zinc, copper, silicone, molybdenum and combinations thereof. The micronutrients may be dissolved or suspended in the aqueous medium. If the micronutrient is dissolved in the aqueous medium, the concentration of the micronutrient is preferably less than 2 wt % more preferably less than 1 wt %, based on the total pesticide suspension. If the micronutrient is suspended in the aqueous medium, the concentration of the micronutrient can be in the range from about 0.1 to about 20 wt %, or about 1 to about 10 wt %, or preferably about 1 to about 5 wt %, based on the total weight of the pesticide SC.

In embodiments of the invention, the solid pesticide is chosen from an insecticide, fungicide, herbicide, growth regulator or combinations thereof. In one embodiment, the solid pesticide is chosen from an insecticide, a fungicide, or a combination thereof. In one aspect, the pesticide is a non-dissociating pesticide which, when added to water, does not dissociate into ions. Examples of suitable pesticides are neonicotinoid insecticides, e.g., imidaclopid or clothianidin; bifenthrin insecticide; captan fungicide; triazole fungicides, e.g., tebuconazole or myclobutanil; strobilurin fungicides, e.g., azoxystrobin, kresoxim-methyl, picoxystrobin, fluoxastrobin, oryzastrobin, dimoxystrobin, pyraclostrobin or trifloxystrobin; ethofumesate herbicide; dinitroaniline herbicides, e.g., pendimethalin; diuron herbicide; and herbicides containing a six-member-ring structure with three nitrogen atoms, e.g., a triazine or triazinone, where examples of a triazine are atrazine and simazine, and examples of a triazinone are metribuzin and metometron.

In one aspect of this invention, a density matching method is used to improve stability of a pesticide suspension by minimizing the density difference between the suspended solid particles and the fluid (i.e., the liquid medium).

In an embodiment, the density of the solid pesticide is determined at a typical operating temperature, e.g., room temperature, and the density of the concentrated fertilizer solution is adjusted to match the density of the pesticide by adjusting the concentration of the fertilizer so that the pesticide is in a stable suspension in the fertilizer solution. In one embodiment, the apparent density of the solid pesticide is determined empirically and simultaneously while adjusting the concentration of the fertilizer solution to match the density of the fertilizer solution with the apparent density of the pesticide.

In one aspect of the invention, the invention is directed to a pesticide suspension composition comprising an aqueous fertilizer solution and a solid pesticide, wherein the composition comprises from about 5 to about 70 wt % fertilizer and from about 0.1 to about 60 wt % pesticide based on the total composition, and wherein the fertilizer concentration is selected to provide the aqueous fertilizer solution with a density (D_{AF}) that sufficiently matches the apparent density of the solid pesticide (D_{P}) to achieve a composition having a stable suspension of pesticide.

If the pesticide suspension is formulated with a concentrated fertilizer solution, for purposes of this application the term “stable suspension” means that, in the concentrated form, there is less than about 20%, or preferably less than about 10%, or more preferably less than about 2%, and most preferably less than 1% volume separation after 4-week storage (of the pesticide SC) at room temperature; or if separation does occur, the suspension is capable of being remixed into a homogeneous system again with gentle mixing. A separated suspension is considered stable as long as it can be remixed into a homogeneous system with gentle mixing. For purposes of this application, gentle mixing means inverting a 100 ml container (holding a sample of 85 g of the pesticide suspension) 15 times. If the formulation is a ready-to-use formulation, either prepared ahead of time or prepared tank side by adding a powder pesticide into a fertilizer solution, a “stable suspension” means that it does not coagulate within about 2 hours after preparing the formulation under gentle stirring.

In one embodiment, the pesticide suspension composition is capable of being dispersed into a second aqueous fertilizer solution in an amount to achieve at least 1 wt % pesticide active, based on the total resulting formulation, and remain stable without forming crystals or coagulation for at least 2 hours. In embodiments of the invention, the density of the aqueous fertilizer (D_{AF}) is (without other additives) at least 1.15, or at least 1.20, or at least 1.25, or at least 1.3, or at least 1.35, or at least 1.4, or at least 1.45, or at least 1.50 g/ml at operating temperature. In embodiments of the invention, the operating temperature is the average temperature that the composition is stored at or the average temperature that the composition will be applied. In embodiments, the operating temperature is in the range from about 0° C. to about 38° C., or about 4° C. to about 27° C., or about 10° C. to about 20° C.

In embodiments of the invention, the density of the aqueous fertilizer (D_{AF}) is selected to achieve a composition having a stable suspension of pesticide in the absence of dispersants, wetting agents, and suspension aids in the case of solid pesticides that are wettable by the aqueous fertilizer solution; or to achieve a composition having a stable suspension of pesticide in the absence of dispersants and suspension aids, and in the presence of an amount of wetting agent necessary for the aqueous fertilizer solution to wet the surface of the solid pesticide in the case of pesticides that are not wettable by the aqueous fertilizer solution.

In one embodiment, the pesticide suspension composition is substantially free of or free of any added dispersants, wetting agents, and suspension aids. In one embodiment, the pesticide suspension composition is substantially free of or free of any added dispersants and suspension aids. In one embodiment, the pesticide suspension composition further comprises a wetting agent. The amount of wetting agent is typically between 0.01% to 5%, preferably 0.05% to 2%, more preferably 0.1% to 1%, based on total SC weight.

In the current art, known pesticide suspensions typically contain more than 10% of additives such as wetting agents, dispersants, suspension aids, and anti-freezes. They are needed mainly for formulation process reasons and they are not essential to crop or soil. It is believed that their use may pollute the environment or harm the seeds if they are applied together with the seeds, e.g., along with a starter fertilizer. Therefore, an ideal pesticide suspension should not contain these additives. If they are necessary for formulation stability or process improvement reasons, the concentration of such additives should be limited to as low as possible. In embodiments of the invention, small amounts of the additives (as described herein) can be included in the pesticide suspension composition to modify the density of the fertilizer solution, the solid pesticide or both, and to assist in the density balancing method according to the present invention.

Using an aqueous fertilizer solution as the suspension medium in accordance with the present invention provides the following advantages:
1. The aqueous pesticide SC, in one embodiment, does not require any other additives in the pesticide suspension other than pesticide itself and the aqueous fertilizer solution. All chemicals, other than the solid pesticides, fertilizers, and water, are considered to be additives.
2. The aqueous pesticide suspension concentrate does not require the addition of an anti-freeze agent because the fertilizer has the ability of depressing the freezing point of water. The fertilizer is not considered to be an anti-freeze agent in the present invention. Without anti-freeze, the aqueous pesticide suspensions in the current arts will crystalize at low temperature. Therefore, the present formulation is substantially free of any added anti-freeze agents. Substantially free means less than 5 wt %, or less than 2 wt %, of less than 1 wt %, or less than 0.5 wt %, or less than 0.1 wt %, or less than 0.01 wt %, based on the total weight of the pesticide SC. In one embodiment, there is no added anti-freeze.
3. It has been found that many chemically unstable pesticide actives have better chemical stability in a concentrated aqueous fertilizer solution. It is believed that when the concentration of the fertilizer is high enough, the aqueous system has very high ionic strength. When water has high ionic strength, the activity of H⁺ and OH⁻ is low and low H⁺ and OH⁻ activity means less reactivity with the active pesticide and more stable active pesticide.
4. It has also been found that many solid pesticides have lower solubility in a concentrated aqueous fertilizer solution. Lower solubility in water means lower potential to show crystal growth of the active pesticide in the suspension.
5. It has also been found that a solid pesticide suspension can be formulated with a concentrated 10-34-0 starter fertilizer solution without coagulation before application.

In the embodiments where additives are present in the present invention, the additives can be chosen from wetting agents, dispersants, suspension aids, and combinations thereof.

Some solid pesticides are hydrophobic or non-polar in nature and they are difficult to mix in an aqueous fertilizer solution. In this case, a wetting agent can be added. A wetting agent is a surfactant and there are many types of wetting agents used in various applications. It has been discovered that not all wetting agents are suitable for the present invention and a suitable wetting agent must be compatible in concentrated fertilizer solutions. Good compatibility means the wetting agent has the ability to dissolve or disperse easily in concentrated fertilizer solutions. It has been discovered that a certain anionic surfactants and certain alkylpolyglucoside surfactants are compatible in concentrated fertilizer solutions. Pesticide suspensions containing the compatible surfactants can be made and such pesticide suspensions can be mixed with water or with concentrated fertilizer solutions.

In embodiments of the invention, the wetting agent is chosen from a phosphate ester, salts of alkyl sulphate, alkyl ether sulphate, alpha olefin sulfonate, C6-C8 alkylpolyglucoside, and combinations thereof. In other embodiments, the wetting agent is chosen from a linear or branched C8 sulfate, C10 sulfate, C12 sulfate, C8 ether sulphate with less than 3 EO units, C8-C16 alpha olefin sulfonate, C4-C6 phosphate ester with less than 6EO units, and combinations thereof. In one preferred embodiment, the wetting agent is chosen from a C8 sulfate, C10 sulfate, C8 ether sulphate with less than 3 EO units, C8 (linear or branched) alpha olefin sulfonate, C14-C16 alpha olefin sulfonate, C4 phosphate ester with less than 4EO units, C6 phosphate ester with less than 3EO units, C6 alkylpolyglucoside, and combinations thereof. Examples of suitable phosphate ester surfactants include PHOSPHOLAN PH-115 and PH-118 from AkzoNobel. In embodiments of the invention, the amount of the additives in the pesticide SC is in the range from about 0.02 to about 10 wt %, or about 0.05 to about 5 wt %, or about 0.1 to about 2 wt %, or about 0.2 to about 1 wt %, based on the total pesticide SC. The pesticide SC of the present invention does not require an anti-freeze. However, if an anti-freeze is present, the presence of the anti-freeze should not affect the formulation stability.

In embodiments of the invention, the stable pesticide suspension has a viscosity of less than 5000 mPa-s, or less than 2000 mPa-s, or less than 1000 mPa-s, or less than 500 mPa-s, measured with a Brookfield viscometer DV-II+ Pro at 100 rpm at room temperature.

It is generally known to use water soluble polymers (WSP), synthetic or naturally derived, to provide thickening to an aqueous solution and that the WSP's can function as a suspension aid by providing thickening and steric repulsion between particles. However, when the concentration of fertilizer is too high, most water soluble polymers including synthetic WSP, xanthan gum, and cellulosic derivatives do not perform well in such a high ionic strength environment. However, some WSP's have been suggested as being electrolyte water thickening polymers where the WSP is capable of hydrating and thickening a high electrolyte solution, e.g., a salt solution. Although small amounts of WSP's can be added, the present invention provides a stable pesticide suspension concentrate without the need to use electrolyte water thickening polymers to provide thickness and act as a suspension aide. Thus, in one aspect, the pesticide suspension composition according to the invention does not contain an electrolyte water thickening polymer of a type and/or an amount that results in a shear thinning aqueous electrolyte solution. In one embodiment, the pesticide suspension composition according to the invention does not contain an electrolyte water thickening polymer (of a type and/or an amount) that results in a composition that displays shear thinning property and has a viscosity of less than 30000 mPa-s (cps) at 25° C. (as measured by a Brookfield viscometer DV-II Pro with a spindle #64 at 60 RPM). In one embodiment, the pesticide suspension composition does not contain guar gum or xanthan gum (of a type and/or an amount) that results in a composition that displays shear thinning property. In one embodiment, the pesticide suspension composition is free of any guar gum or xanthan gum materials that are electrolyte water thickening polymers. In one embodiment, the pesticide suspension composition is free of any electrolyte water thickening polymers.

The invention is now illustrated by the following examples.

### Example 1. Quick Screening of Crystal Growth Potential in Fertilizer Concentrates and Water for Selected Solid Pesticides Containing No Carboxylic Acid Group

Crystal formation in a suspension concentrate is a complex phenomenon. It is believed that if the solubility of the suspended solid chemical is high in the medium, the suspension concentrate is prone to form crystals of the suspended solid chemical in storage. This example demonstrates a quick screening tool to see if a solid pesticide is suitable or not to be formulated into a suspension in fertilizer solutions without crystal formation. The concentrations of the solid pesticides used in this example were low (at a typical ready-to-apply concentration range). If a solid pesticide forms crystals in such a low concentration, it is not suitable for a ready-to-apply pesticide suspension and mostly likely will not be suitable for a more concentrated suspension in fertilizer. If the solid pesticide has low solubility in the medium and it does not form crystal at low concentrations, the solid pesticide will be also suitable for more concentrated pesticide suspensions. By “not suitable” is meant that although it may work to some extent, it is not a good candidate for the pesticide SC.

Samples were prepared by adding the components followed by hand-shaking.

TABLE 2
Study of crystal formation for pesticide formulations.

| | Powder | | | | Wetting | | |
|---|---|---|---|---|---|---|---|
| ID | pesticide | wt % | Medium | wt % | agent | wt % | Comment |
| 1 | Captan | 1 | Water | 99 | | | No crystal growth between |
| | | | | | | | 0-40° C. Powder sank. |
| | | | | | | | Suitable |
| 2 | Captan | 1 | 10-34-0 | 99 | | | No crystal growth between |
| | | | | | | | 0-40° C. Powder sank. |
| | | | | | | | Suitable |
| 3 | Captan | 1 | URAN 32 | 99 | | | No crystal growth between |
| | | | | | | | 0-40° C. Powder sank. |
| | | | | | | | Suitable |
| 4 | Captan | 1 | 40% AMS | 99 | | | No crystal growth between |
| | | | | | | | 0-40° C. Powder sank. |
| | | | | | | | Suitable |
| 5 | Trifloxystrobin | 1 | Water | 99 | | | No crystal growth between |
| | | | | | | | 0-40° C. Powder sank. |
| | | | | | | | Suitable |
| 6 | Trifloxystrobin | 1 | 10-34-0 | 99 | | | No crystal growth between |
| | | | | | | | 0-40° C. Powder sank. |
| | | | | | | | Suitable |
| 7 | Trifloxystrobin | 1 | URAN 32 | 99 | | | No crystal growth between |
| | | | | | | | 0-40° C. Powder sank. |
| | | | | | | | Suitable |
| 8 | Trifloxystrobin | 1 | 40% AMS | 99 | | | No crystal growth between |
| | | | | | | | 0-40° C. Powder sank. |
| | | | | | | | Suitable |
| 9 | Imidaclopid | 1 | Water | 99 | | | No crystal growth between |
| | | | | | | | 0° C. and 40° C. Some |
| | | | | | | | powder sank and some |
| | | | | | | | floated. Suitable |
| 10 | Imidaclopid | 1 | 10-34-0 | 99 | | | No crystal growth between |
| | | | | | | | 0° C. and 40° C. Some |
| | | | | | | | powder sank and some |
| | | | | | | | floated. Suitable |
| 11 | Imidaclopid | 1 | URAN 32 | 99 | | | Dissolved. Not suitable |
| 12 | Imidaclopid | 1 | 40% AMS | 99 | | | No crystal growth between |
| | | | | | | | 0° C. and 40° C. Some |
| | | | | | | | powder sank and some |
| | | | | | | | floated. Suitable |
| 13 | Atrazine | 1 | Water | 99 | | | No crystal growth between |
| | | | | | | | 0° C. and 40° C. Some |
| | | | | | | | powder sank and some |
| | | | | | | | floated. Suitable |
| 14 | Atrazine | 1 | 10-34-0 | 99 | | | No crystal growth between |
| | | | | | | | 0° C. and 40° C. Powder |
| | | | | | | | floated. Suitable |
| 15 | Atrazine | 1 | URAN 32 | 99 | | | No crystal growth between |
| | | | | | | | 0° C. and 40° C. Powder |
| | | | | | | | floated. Suitable |
| 16 | Atrazine | 1 | 40% AMS | 99 | | | No crystal growth between |
| | | | | | | | 0° C. and 40° C. Some |
| | | | | | | | powder sank and some |
| | | | | | | | floated. Suitable |
| 17 | Diuron | 1 | Water | 99 | | | No crystal growth between |
| | | | | | | | 0° C. and 40° C. Some |
| | | | | | | | powder sank and some |
| | | | | | | | floated. Suitable |
| 18 | Diuron | 1 | 10-34-0 | 99 | | | No crystal growth between |
| | | | | | | | 0 C. and 40 C. Some powder |
| | | | | | | | sank and some floated. |
| | | | | | | | Suitable |
| 19 | Diuron | 1 | URAN 32 | 99 | | | No crystal growth between |
| | | | | | | | 0° C. and 40° C. Powder |
| | | | | | | | sank. Suitable |
| 20 | Diuron | 1 | 40% AMS | 99 | | | No crystal growth between |
| | | | | | | | 0° C. and 40° C. Some |
| | | | | | | | powder sank and some |
| | | | | | | | floated. Suitable |
| 21 | Myclobutanil | 1 | Water | 99 | | | No crystal growth between |
| | | | | | | | 0° C. and 40° C. Powder |
| | | | | | | | sank. Suitable |
| 22 | Myclobutanil | 1 | 10-34-0 | 99 | | | No crystal growth between |
| | | | | | | | 0° C. and 40° C. Powder |
| | | | | | | | floated. Suitable |
| 23 | Myclobutanil | 1 | URAN 32 | 99 | | | No crystal growth between |
| | | | | | | | 0° C. and 40° C. Powder |
| | | | | | | | floated. Suitable |
| 24 | Myclobutanil | 1 | 40% AMS | 99 | | | No crystal growth between |
| | | | | | | | 0° C. and 40° C. Powder |
| | | | | | | | sank. Suitable |
| 25 | Imidaclopid | 1 | Water | 98 | Witcolate D- | 1 | No crystal growth between |
| | | | | | 510 | | 0° C. and 40° C. Powder |
| | | | | | | | sank. Suitable |
| 26 | Imidaclopid | 1 | 10-34-0 | 98 | Witcolate D- | 1 | No crystal growth between |
| | | | | | 510 | | 0° C. and 40° C. Some |
| | | | | | | | powder sank and some |
| | | | | | | | floated. Suitable |
| 27 | Imidaclopid | 1 | URAN 32 | 98 | Witcolate D- | 1 | Dissolved. Not suitable |
| | | | | | 510 | | |
| 28 | Imidaclopid | 1 | 40% AMS | 98 | Witcolate D- | 1 | No crystal growth between |
| | | | | | 510 | | 0° C. and 40° C. Powder |
| | | | | | | | sank. Suitable |
| 29 | Atrazine | 1 | Water | 98 | Witcolate D- | 1 | No crystal growth between |
| | | | | | 510 | | 0° C. and 40° C. Powder |
| | | | | | | | sank. Suitable |
| 30 | Atrazine | 1 | 10-34-0 | 98 | Witcolate D- | 1 | No crystal growth between |
| | | | | | 510 | | 0° C. and 40° C. Powder |
| | | | | | | | floated. Suitable |
| 31 | Atrazine | 1 | URAN 32 | 98 | Witcolate D- | 1 | No crystal growth between |
| | | | | | 510 | | 0° C. and 40° C. Powder |
| | | | | | | | floated. Suitable |
| 32 | Atrazine | 1 | 40% AMS | 98 | Witcolate D- | 1 | No crystal growth between |
| | | | | | 510 | | 0° C. and 40° C. Powder |
| | | | | | | | floated. Suitable |
| 33 | Diuron | 1 | Water | 98 | Witcolate D- | 1 | No crystal growth between |
| | | | | | 510 | | 0° C. and 40° C. Powder |
| | | | | | | | sank. Suitable |
| 34 | Diuron | 1 | 10-34-0 | 98 | Witcolate D- | 1 | No crystal growth between |
| | | | | | 510 | | 0° C. and 40° C. Some |
| | | | | | | | powder sank and some |
| | | | | | | | floated. Suitable |
| 35 | Diuron | 1 | URAN 32 | 98 | Witcolate D- | 1 | No crystal growth between |
| | | | | | 510 | | 0° C. and 40° C. Powder |
| | | | | | | | sank. Suitable |
| 36 | Diuron | 1 | 40% AMS | 98 | Witcolate D- | 1 | No crystal growth between |
| | | | | | 510 | | 0° C. and 40° C. Powder |
| | | | | | | | sank. Suitable |
| 37 | Myclobutanil | 1 | Water | 98 | Witcolate D- | 1 | No crystal growth between |
| | | | | | 510 | | 0° C. and 40° C. Powder |
| | | | | | | | sank. Suitable |
| 38 | Myclobutanil | 1 | 10-34-0 | 98 | Witcolate D- | 1 | No crystal growth between |
| | | | | | 510 | | 0° C. and 40° C. Powder |
| | | | | | | | floated. Suitable |
| 39 | Myclobutanil | 1 | URAN 32 | 98 | Witcolate D- | 1 | No crystal growth between |
| | | | | | 510 | | 0° C. and 40° C. Powder |
| | | | | | | | floated. Suitable |
| 40 | Myclobutanil | 1 | 40% AMS | 98 | Witcolate D- | 1 | No crystal growth between |
| | | | | | 510 | | 0° C. and 40° C. Powder |
| | | | | | | | floated. Suitable |
| 41 | Bifenthrin | 1 | Water | 98 | Witcolate D- | 1 | No crystal growth between |
| | | | | | 510 | | 0° C. and 40° C. Powder |
| | | | | | | | sank. Suitable |
| 42 | Bifenthrin | 1 | 10-34-0 | 98 | Witcolate D- | 1 | No crystal growth between |
| | | | | | 510 | | 0° C. and 40° C. Powder |
| | | | | | | | floated. Suitable |
| 43 | Bifenthrin | 1 | URAN 32 | 98 | Witcolate D- | 1 | No crystal growth between |
| | | | | | 510 | | 0° C. and 40° C. Powder |
| | | | | | | | floated. Suitable |
| 44 | Bifenthrin | 1 | 40% AMS | 98 | Witcolate D- | 1 | No crystal growth between |
| | | | | | 510 | | 0° C. and 40° C. Powder |
| | | | | | | | sank. Suitable |

The liquid 10-34-0 fertilizer was ammonium polyphosphate from Plant Food Company Inc.

A review of table 2 reveals that captan, trifloxystrobin, imidacloprid, atrazine, diuron, myclobutanil, and bifenthrin did not have crystal growth in the fertilizer solutions tested and they are suitable for formulating low concentration and high concentration suspensions in fertilizer solutions in accordance with the present invention. The exception is imidacloprid in URAN 32 (samples 11 and 27) where high solubility of imidacloprid in URAN 32 may present a crystal formation issue in suspension and make it less preferred.

There was no coagulation in all the samples. The solid particles in the 10-34-0 solution either sank or floated. However, they were able to be suspended under gentle stirring.

Some solid pesticides were not dispersible in the fertilizer solutions. In this case, use of wetting agent was necessary. However, even with a readily dispersible solid pesticide in fertilizer solutions, use of an appropriate wetting agent can help suspension stability.

### Example 2. Quick Screening of Crystal Growth Potential in Fertilizer Concentrates and Water for Selected Solid Pesticides Containing a Carboxylic Acid Group

Samples were prepared by adding the components followed by hand-shaking. Samples were placed at 0° C. and observation was made after 1 day, unless otherwise specified.

TABLE 3
Study of crystal formation for pesticides containing a carboxylic acid group.

| | Powder | | | | Wetting | | |
|---|---|---|---|---|---|---|---|
| ID | pesticide | wt % | Medium | wt % | agent | wt % | Comment |
| 1 | Glyphosate | 2 | Water | 98 | | | Not dissolved. Powder sank. |
| | acid | | | | | | Crystal growth at room temp. Not |
| | | | | | | | suitable |
| 2 | Glyphosate | 2 | 10-34-0 | 98 | | | Dissolved at room temp. Not |
| | acid | | | | | | suitable |
| 3 | Glyphosate | 30 | 10-34-0 | 70 | | | Powder not dissolved. Powder |
| | acid | | | | | | sank and became cake. Sample |
| | | | | | | | became cold while mixing. |
| | | | | | | | Crystal growth on container wall |
| | | | | | | | at room temp. Not suitable |
| 4 | Glyphosate | 2 | 40% AMS | 98 | | | Dissolved. Not suitable |
| | acid | | | | | | |
| 5 | Glyphosate | 2 | URAN 32 | 98 | | | Almost all powder dissolved. A |
| | acid | | | | | | little powder at bottom. Not |
| | | | | | | | suitable |
| 6 | 2,4-D acid | 1.3 | Water | 98.7 | | | Not dissolved. Powder sank. |
| | | | | | | | Crystal growth between powder |
| | | | | | | | particles. Not suitable |
| 7 | 2,4-D acid | 1.3 | 10-34-0 | 98.7 | | | Not dissolved. Powder sank. |
| | | | | | | | Crystal growth between powder |
| | | | | | | | particles. Not suitable |
| 8 | 2,4-D acid | 1.3 | 40% AMS | 98.7 | | | Not dissolved. Powder sank. |
| | | | | | | | Crystal growth between powder |
| | | | | | | | particles. Not suitable |
| 9 | 2,4-D acid | 1.3 | URAN 32 | 98.7 | | | Not dissolved. Powder sank. |
| | | | | | | | Crystal growth between powder |
| | | | | | | | particles. Not suitable |
| 10 | Dicamba | 1 | Water | 99 | | | Crystal formed at 0 C. and |
| | acid | | | | | | remains at room temp at bottom. |
| | | | | | | | Not suitable |
| 11 | Dicamba | 1 | 10-34-0 | 99 | | | Crystal formed at bottom at 0 C. |
| | acid | | | | | | Not suitable |
| 12 | Dicamba | 1 | 40% AMS | 99 | | | Oily drop formed at bottom. |
| | acid | | | | | | |
| 13 | Dicamba | 1 | URAN 32 | 99 | | | Dissolved. Clear solution. Not |
| | acid | | | | | | suitable |
| 14 | Picloram | 1 | 10-34-0 | 99 | | | No crystal growth between 0 C. |
| | | | | | | | and 40 C. Powder sank. Suitable |
| 15 | Picloram | 1 | URAN 32 | 99 | | | Powder almost dissolved. May |
| | | | | | | | not be suitable |
| 16 | Picloram | 1 | 40% AMS | 99 | | | No crystal growth between 0 C. |
| | | | | | | | and 40 C. Powder sank. Suitable |
| 17 | Picloram | 1 | Water | 98 | Witcolate | 1 | No crystal growth between 0 C. |
| | | | | | D-510 | | and 40 C. Powder sank. Suitable |
| 18 | Picloram | 1 | 10-34-0 | 98 | Witcolate | 1 | No crystal growth between 0 C. |
| | | | | | D-510 | | and 40 C. Some powder sank and |
| | | | | | | | some floated. Suitable |
| 19 | Picloram | 1 | URAN 32 | 98 | Witcolate | 1 | No crystal growth between 0 C. |
| | | | | | D-510 | | and 40 C. Powder sank. Suitable |
| 20 | Picloram | 1 | 40% AMS | 98 | Witcolate | 1 | No crystal growth between 0 C. |
| | | | | | D-510 | | and 40 C. Powder sank. Suitable |
| 21 | Clopyralid | 1 | Water | 99 | | | Dissolved. Not suitable |
| 22 | Clopyralid | 1 | 10-34-0 | 99 | | | Not dissolved. Powder floated. |
| | | | | | | | No crystal growth. Suitable |
| 23 | Clopyralid | 1 | URAN 32 | 99 | | | Dissolved. Not suitable |
| 24 | Clopyralid | 1 | 40% AMS | 99 | | | Not dissolved. Powder sank. |
| | | | | | | | Crystal growth at room temp. Not |
| | | | | | | | suitable |
| 25 | Clopyralid | 1 | 10-34-0 | 98 | Witcolate | 1 | No crystal growth between 0 C. |
| | | | | | D-510 | | and 40 C. Powder floated. |
| | | | | | | | Suitable |

The liquid 10-34-0 fertilizer was ammonium polyphosphate from Plant Food Company Inc.

The pesticides used in this example all contain a carboxylic acid group, which have the potential to dissociate into ions (COO⁻ and H⁺) in aqueous solutions. A review of table 2 and table 3 reveals that using aqueous fertilizer solutions as a suspension medium to suspend solid pesticides is not suitable for all pesticides. The results in table 3 indicate that glyphosate acid herbicide, 2,4-D acid herbicide, dicamba acid herbicide, and clopyralid herbicide may not be suitable for the present invention because they are prone to form crystals. The exception is clopyralid in 10-34-0 fertilizer. However, picloram appears to be suitable in all fertilizer solutions (except URAN32 #15 in Table 3) studied. The results suggest that a dissociating solid pesticide is not preferred in the present invention.

### Example 3. Suspension of Clothianidin Insecticide in 10-34-0 Aqueous Fertilizer to Study the Effect of Concentration on Stability

Various amounts of clothianidin were added to 10-34-0 fertilizer. Samples were shaken by hand until homogeneous. Mixing clothianidin with 10-34-0 was found to be quite easy.

TABLE 4
Study of clothianidin insecticide in 10-34-0 fertilizer.

| | Grams of | Grams of | |
|---|---|---|---|
| Sample | clothianidin | 10-34-0 | 2 days at 50 C. |
| 1 | 30 | 70 | Low viscosity. Some powder sank |
| | | | to the bottom and some on top |
| | | | with middle clear phase. No |
| | | | crystal growth. Stable. |
| 2 | 40 | 60 | Thicker than sample 1. Bottom |
| | | | clear with <10% separation. Most |
| | | | powder floated to top with a |
| | | | little powder at bottom. Sample |
| | | | was able to go back to the smooth |
| | | | look after re-shaking. No crystal |
| | | | growth. Stable. |

A review of table 4 reveals that 10-34-0 fertilizer, having a density of about 1.40 g/ml, was able to suspend clothianidin powder without crystal formation and without coagulation. It appears that the high density of 10-34-0 was sufficiently matched to suspend the clothianidin at the concentrations tested.

It was found that sample 1 and 2 stability may be further improved with a suitable thickener additive. The samples can be used alone, diluted with water, easily dispersed to a fertilizer concentrate including 10-34-0, URAN 32, URAN 28 and 28-40% ammonium sulfphate (AMS) without forming crystals or coagulation.

### Example 4. Study of 40% Clothianidin Insecticide in 60% Mixed Fertilizer (10-34-0 and URAN 32 in Various Ratio) Using Density Matching Method

Samples were prepared by adding clothianidin insecticide to a 60 wt % mixed fertilizer (10-34-0 and URAN 32 in various ratios) in an amount to provide a 40 wt % clothianidan SC, by hand shaking or homogenization.

TABLE 5
Study of 40 wt % clothianidin insecticide SC in a 60 wt % mixed
fertilizer (10-34-0 and URAN 32) in various ratios.

| | | URAN | | 2 weeks at | 4 weeks at | 4 weeks at |
|---|---|---|---|---|---|---|
| Smpl | 10-34-0 | 32 | Solid particle | 50° C. | room temp | −20° C. |
| A | 100 | 0 | Float to top. | Stable | Stable | Stable |
| | | | Bottom clear | | | |
| B | 85 | 15 | Float to top. | Stable | Stable | Stable |
| | | | Bottom clear | | | |
| C | 82 | 18 | Float to top. | Stable | Stable | Stable |
| | | | Bottom clear | | | |
| D | 80 | 20 | Float to top. | Stable | Stable | Stable |
| | | | Bottom clear | | | |
| E | 78.33 | 21.67 | Stable in | Viscous. 2 | Low viscosity. | Lower |
| | | | system | weeks <10% | No visible | viscosity. <10% |
| | | | | separation. No | separation. No | separation. No |
| | | | | crystal growth. | crystal growth. | crystal growth. |
| F | 77 | 23 | Sank to bottom. | ~10% | <10% | <10% |
| | | | Top clear | separation. | separation. | separation. |
| | | | | Able to re-mix | Able to re-mix | Able to re-mix |
| G | 75 | 25 | Sank to bottom. | ~10% | <10% | <10% |
| | | | Top clear | separation. | separation. | separation. |
| | | | | Able to re-mix | Able to re-mix | Able to re-mix |
| H | 70 | 30 | Sank to bottom. | >10% | >10% | >10% |
| | | | Top clear | separation. | separation. | separation. |
| | | | | Able to re-mix. | Able to re-mix. | Able to re-mix. |
| | | | | No crystal | No crystal | No crystal |
| | | | | growth | growth | growth |
| I | 0 | 100 | Sank to bottom. | >10% | >10% | >10% |
| | | | Top clear | separation. | separation. | separation. |
| | | | | Able to re-mix. | Able to re-mix. | Able to re-mix. |
| | | | | No crystal | No crystal | No crystal |
| | | | | growth | growth | growth |
| J* | 78.33 | 21.67 | Very stable in | Very viscous. | Good viscosity. | Lower |
| | | | system | 2 weeks Little | Little to no | viscosity. Little |
| | | | | to no | visible | to no visible |
| | | | | separation. No | separation. No | separation. No |
| | | | | crystal growth. | crystal growth. | crystal growth. |
| | | | | Stable | Stable | Stable |

*homogenized at 13000 rpm for 5 minutes

A review of Table 5 reveals the solid particles in sample A floated to the top and the solid particles in sample I sank to bottom. The density of the mixed fertilizer solution was balanced to match the solid particles of the pesticide to achieve optimized stability by balancing the concentration of the two fertilizer materials. The optimum weight ratio of 10-34-0 to URAN 32 appears to be at around 78.33:21.67, based on the amount of active fertilizer. For a different loading of clothianidin insecticide, the optimized ratio may be different but it can be determined using the method described in this example. This is another example of the density matching method of the present invention by using two different fertilizer solutions with two different densities.

The viscosity of sample J (room temperature sample) was measured with a Brookfield viscometer at various rpm at room temperature with a #64 spindle. At low rpm of a Brookfield viscometer spindle, a substance is exposed to low shear rate. As the rpms increase, the substance is exposed to high shear rate. The viscosity values are shown in the following table.

TABLE 6
Viscosity of sample J SC.

| RPM | mPa-s, 24° C. (3 days) | mPa-s, 24° C. (6 weeks) |
|---|---|---|
| 1 | 10000 | 4000 |
| 2 | 7200 | 3900 |
| 4 | 4800 | 3000 |
| 10 | 3400 | 2200 |
| 20 | 2000 | 1500 |
| 50 | 1460 | 1050 |
| 100 | 880 | 780 |

Sample J was easily picked up with a plastic pipette. Since it had high viscosity at low shear rate (low rpm), the suspended particles were very stable. It was observed that the viscosity of a fresh sample (less than 1 day old) was lower at −20° C. than the viscosity at room temperature, which in turn was lower than the viscosity at 50° C. This is a good physical property because most agro products are applied in early spring when the temperature is still cold.

When sample J was removed from a 50° C. oven after 4 days, the viscosity was somewhat higher than the viscosity of the room temp sample. After about 1 month at 50° C., sample J became very viscous at 50° C.

This sample J formulation can be used alone, diluted with water, or easily dispersed into a fertilizer concentrate including 10-34-0, URAN 32, URAN 28, 27-4-0, 21-21-21, 13-27-27, and 28-40% ammonium sulphate (AMS) without forming crystals or coagulation.

### Example 5. Suspension Concentrate (SC) of a Clothianidin Insecticide in 10-34-0 Fertilizer with a Wetting Agent

This example shows the effect of wetting agent Witcolate D-510 (2-ethylhexyl sulfate) on the stability of 40% clothianidin SC. The test samples were prepared by adding 60 grams of 10-34-0 fertilizer (from Plant Food) to a bottle. Then various amounts of Witcolate D-510 (2-ethylhexyl sulfate) were added to the 10-34-0 fertilizer and mixed well. Finally, 40 grams of clothianidin (technical grade) was added to the mixture and mixed well by shaking by hand.

TABLE 7
Study of clothianidin insecticide in 10-34-0 fertilizer with a wetting agent.

| | Grams of 2- | | | |
|---|---|---|---|---|
| | EH-3 sulfate | | After 4 weeks | After 4 weeks |
| Sample | in 100 g SC | After 40° C. treatment | at −20 C. | at room temp |
| 1 | 0 | 1 day at 40° C.: A little | | Bottom clear with <10% |
| | | bottom clear. Most solid | | separation. Most |
| | | floated to top with a | | solid floated to top |
| | | little solid at bottom. | | with a little solid at |
| | | Stable | | bottom. No crystal |
| | | | | growth. Stable |
| 2 | 0.2 | 4-weeks at 40° C.: <10% | <10% separation | <10% separation with |
| | | separation with a | with a little bottom | a little bottom clear. |
| | | little bottom clear. | clear. No crystal | Moderate viscosity. No |
| | | Viscosity slightly higher | growth. Viscosity | crystal growth. Stable |
| | | than room temp sample | slightly lower than | |
| | | measured at 40° C. | room temp sample | |
| | | Stable | measured at −20 C. | |
| | | | Stable | |
| 3 | 0.25 | 4-weeks at 40° C.: <10% | <10% separation. | <10% separation. |
| | | separation. No | No crystal growth. | Moderate viscosity. No |
| | | crystal growth. | Viscosity lower | crystal growth. Stable |
| | | Viscosity slightly higher | than room temp | |
| | | than room temp | sample. Stable | |
| | | sample. Stable | | |
| 4 | 0.5 | 1 day at 40° C.: | | Top clear. All solid |
| | | Significant separation | | sank to the bottom. |
| | | with top clear. All solid | | Not stable |
| | | sank to the bottom. Not | | |
| | | stable | | |
| 5 | 0.25 | 4-weeks at 40° C.: <5% | <5% separation. | <5% separation. No |
| (homo- | | separation. Viscosity | No crystal growth. | crystal growth. |
| genized) | | higher than sample 3. | Viscosity higher | Viscosity higher than |
| | | Stable | than sample 3. | sample 3. Stable |
| | | | Stable | |

A review of Table 7 reveals that the wetting agent Witconate D-510 appears to have the ability to change or balance the density difference between the solid particle and the fertilizer solution, hence to change the stability of the suspension. This example shows a density matching method of the present invention that includes adjusting the concentration of wetting agents. At low wetting agent concentration, the solid particles floated to the top. As the concentration of Witcolate D-510 was increased to 0.5 wt %, all solid particles sank to the bottom. It was found that the optimized concentration was at 0.25 wt % (sample 3), where the density difference appears to be mostly balanced and the sample had the best stability. This SC was able to flow easily and had less than about 10% separation at 40° C. for 4 weeks and was able to be re-mixed easily. It also had less than 10% separation, was free of crystals, and still flowed nicely even at −20° C. for 4 weeks. This sample had better stability when it was homogenized (Sample 5) due to smaller particle size).

The optimized concentration of the wetting agent Witcolate D-510 will be different if the concentration of the clothianidin is different and/or if other pesticides are used. It can be determined by using the method described in this example.

Samples 1, 2 and 3 can be used alone, diluted with water, easily dispersed with a fertilizer concentrate including 10-34-0, URAN 32, URAN 28, 21-21-21, 13-27-27, 27-4-0, and 28-40% ammonium sulphate (AMS) without forming crystals or coagulation.

Other surfactants in place of Witcolate D-510 have been used to produce similar clothianindin suspensions. The optimum amount of surfactant required to produce the most stable suspension varies. Examples of suitable surfactants included Witconate AOS (014-16 alpha olefin sulfonate), Witconate AOS-12 (C12 alpha olefin sulfonate), Witconate AOS-10 (010 alpha olefin sulfonate), Witconate NAS-8 (or Witconate NAS-88, C8 alpha olefin sulfonate), AG 6206 (C6 alkylpolyglucoside), and C4-C6 phosphate ester with less than 7EO units (acid form).

It was also discovered that it was difficult to prepare clothianidin SC having a concentration greater than 40 wt % in this system.

### Example 6. Study of 50% Clothianidin Insecticide in 50% URAN 32 Fertilizer

0.5 g Witcolate D-510 surfactant was added into 100 g URAN 32 fertilizer solution (50 wt % URAN 32 in water). The D-510 surfactant dissolved in URAN 32 readily. Then 100 g clothianidin was added to the resulting solution and mixed well by hand-shaking. This sample was stable and had about 10% top clear with a smooth bottom suspension after 2 weeks at 40° C. However, using homogenization method, the composition did not show noticeable separation.

In other experiments, 0.3% of a pH adjusting agent (40 wt % Citric acid), was included in the SC sample (homogenized sample) and no noticeable effect was observed on stability. Viscosity measurements were made with a Brookfield viscometer at various speeds (rpm) at room temperature with a #64 spindle. This sample was very viscous but it was highly shear-thinning. The viscosity values are shown in the following table.

TABLE 8
Viscosity of 50% clothianidin in 50%
URAN 32 sample by hand-shaking.

| RPM | mPa-s, 24° C. |
|---|---|
| 1 | 10200 |
| 2 | 6900 |
| 4 | 3900 |
| 10 | 2300 |
| 20 | 1500 |
| 50 | 1300 |
| 100 | 1200 |

In this system, it was found that higher than about 55 wt % clothianidin resulted in a paste.

It appears the density of clothianidin is higher than URAN 32 (having a density of about 1.32 g/ml) because clothianidin sank to the bottom at all concentrations. However, since the density of URAN 32 is also relatively high, URAN 32 had the ability to suspend the clothianidin particles to a point where the amount of separation was acceptable. By including additives, such as dispersant and/or suspension aid, it is believed the separation would be expected to decreased.

This suspension can be used alone, diluted with water, easily dispersed to a fertilizer concentrate including 10-34-0, URAN 32, URAN 28 and 28-40% ammonium sulfphate (AMS) without forming crystals or coagulation.

### Example 7. Wetting Agent Screening to Determine Suitable Wetting Agents in 10-34-0 Fertilizer

There are many wetting agents but not all wetting agents are suitable for the present invention. A suitable wetting agent is the one that can dissolve or disperse at least about 1 wt % (based on 100% active) in the fertilizer, and the fertilizer solution is able to wet the pesticide solid surfaces. The following data was obtained by mixing a small amount of a wetting agent in 10-34-0 fertilizer solution, followed by observing the appearance and its wetting on a hydrophobic polyester surface, which was used to simulate pesticide solid surfaces.

TABLE 9
Study of wetting agents in 10-34-0 fertilizer
on a hydrophobic surface.

| | | | | Wetting | |
|---|---|---|---|---|---|
| | | | | on hy- | |
| | | | | drophobic | |
| | wt % | | | polyester | |
| Smpl | of 10- | | | weighing | |
| # | 34-0 | Surfactant | wt % | dish | Appearance |
| 1 | 100 | | | Poor. | Clear green |
| | | | | Contact | solution |
| | | | | angle >90 | (Reference) |
| 2 | 70 | Witconate NAS-8 | 30.00 | Good | Clear solution |
| 3 | 99 | Witconate NAS-8 | 1.00 | Good | Clear solution |
| 4 | 99.5 | Witconate NAS-8 | 0.50 | Good | Clear solution |
| 5 | 99.8 | Witconate NAS-8 | 0.20 | Good | Clear solution |
| 6 | 99.9 | Witconate NAS-8 | 0.10 | Good | Clear solution |
| 7 | 99.95 | Witconate NAS-8 | 0.05 | Good | Clear solution |
| 8 | 95 | Phospholan PS-413 | 5.00 | Excellent | Clear solution |
| 9 | 99 | Phospholan PS-413 | 1.00 | Excellent | Clear solution |
| 10 | 99.5 | Phospholan PS-413 | 0.50 | Excellent | Clear solution |
| 11 | 99.8 | Phospholan PS-413 | 0.20 | Excellent | Clear solution |
| 12 | 99.9 | Phospholan PS-413 | 0.10 | Very good | Clear solution |
| 13 | 99.95 | Phospholan PS-413 | 0.05 | Good | Clear solution |
| 14 | 95 | Phospholan HE- | 5.00 | Very good | Dispersed |
| | | 6641 | | | |
| 15 | 99 | Phospholan HE- | 1.00 | Very good | Dispersed |
| | | 6641 | | | |
| 16 | 99.5 | Phospholan HE- | 0.50 | Very good | Dispersed |
| | | 6641 | | | |
| 17 | 99.8 | Phospholan HE- | 0.20 | Very good | Dispersed |
| | | 6641 | | | |
| 18 | 99.9 | Phospholan HE- | 0.10 | Good | Dispersed |
| | | 6641 | | | |
| 25 | 99.95 | Phospholan HE- | 0.05 | Good | Dispersed |
| | | 6641 | | | |

A review of table 9 reveals that Witconate NAS-8, Phospholan PS-413 (C4-1EO phosphate ester), and Phospholan HE-6641 (C4-3EO phosphate ester) were found to be suitable for in-can formulation with 10-34-0 fertilizer, diluted or undiluted. They were also determined to be suitable for tank mix application if desired.

### Example 8. Study of Additional Surfactants in 10-30-0, 27-4-0 and Diluted 10-34-0 Fertilizers

Example 7 was repeated, except that the surfactants in 27-4-0 or diluted 10-34-0 were studied.

TABLE 10
Study of other surfactants in 10-34-0, 27-4-0 and diluted 10-34-0 fertilizers.

| | | | | | | | | Surfactant |
|---|---|---|---|---|---|---|---|---|
| Smpl # | Fertilizer | wt | Water | wt | Surfactant | wt | Appearance | Suitability |
| 1 | 10-34-0 | 10 | | | Witconate 3203 | 2.05 | Clear | 10-34-0 |
| | | | | | (C10 AOS, Na) | | | |
| 2 | 10-34-0 | 99 | | | Linear C8 | 1 | Almost | 10-34-0 |
| | | | | | phosphate ester | | Clear | |
| 3 | 10-34-0 | 99 | | | AG 6206 (C6 | 1 | Clear | 10-34-0 |
| | | | | | polyglucocide) | | | |
| 4 | 10-34-0 | 99 | | | Linear C6 | 1 | Clear or | 10-34-0 |
| | | | | | phosphate ester | | very slight | |
| | | | | | with 6EO | | haze | |
| 5 | 10-34-0 | 60.6 | Water | 24.7 | Witconate AOS-12 | 14.7 | Clear | Diluted 10-34-0 |
| | | | | | C12 alpha olefin | | | |
| | | | | | sulfonate | | | |
| 6 | 10-34-0 | 60 | Water | 30 | Witconate AOS | 10 | Clear, | Diluted 10-34-0 |
| | | | | | C14-16 alpha | | viscous | |
| | | | | | olefin sulfonate | | | |
| 7 | 10-34-0 | 26.7 | Water | 13.3 | Witconate AOS | 60 | Clear, | Diluted 10-34-0 |
| | | | | | | | highly | |
| | | | | | | | viscous | |
| 8 | 10-34-0 | 59.2 | Water | 26.6 | Witconate AOS | 14.2 | Clear, | Diluted 10-34-0 |
| | | | | | | | viscous | |
| 9 | 10-34-0 | 61 | Water | 33.3 | Sodium C810 | 5.7 | SI. Hazy, no | Diluted 10-34-0 |
| | | | | | sulfate (40%) | | separation | |
| 10 | 10-34-0 | 56.1 | Water | 30.7 | Sodium C810 | 13.2 | Clear | Diluted 10-34-0 |
| | | | | | sulfate (40%) | | | |
| 11 | 10-34-0 | 37.5 | Water | 50.9 | Witcolate SLS | 11.6 | Clear, | Diluted 10-34-0 |
| | | | | | (Sodium lauryl | | viscous | |
| | | | | | sulfate) | | | |
| 12 | 27-4-0 | 81.2 | | | Sodium C810 | 18.8 | Clear | 27-4-0 |
| | | | | | sulfate (40%) | | | |
| 13 | 27-4-0 | 89.4 | | | C810-3EO sulfate | 10.6 | Clear | 27-4-0 |
| | | | | | (40%) | | | |
| 14 | 27-4-0 | 76.6 | | | Witcolate D510 | 23.4 | Clear | 27-4-0 |
| | | | | | (2-EH sulfate) | | | |
| 15 | 27-4-0 | 96.1 | | | Witconate AOS | 3.9 | Clear | 27-4-0 |
| 16 | 27-4-0 | 88 | | | Witconate AOS | 12 | Clear, | 27-4-0 |
| | | | | | | | viscous | |
| 17 | 27-4-0 | 80 | | | Witconate AOS | 20 | Clear, | 27-4-0 |
| | | | | | | | viscous | |
| 18 | 27-4-0 | 80 | | | Witconate AOS-12 | 20 | Clear | 27-4-0 |
| 19 | 27-4-0 | 91.3 | | | Witconate ES-2 | 8.7 | Clear | 27-4-0 |
| | | | | | (Sodium Laureth-2 | | | |
| | | | | | sulfate) | | | |
| 20 | 27-4-0 | 99.4 | | | Tween 20 | 0.6 | Clear | 27-4-0 |
| | | | | | (Polysorbate-20) | | | |
| 21 | 27-4-0 | 95 | | | Phospholan PS- | 5 | Clear | 27-4-0 |
| | | | | | 131 | | | |
| 22 | 27-4-0 | 99.4 | | | Ethylan SN-50 | 0.6 | Fish eyes & | Not suitable |
| | | | | | (Linear C10 | | separate | |
| | | | | | alcohol ethoxylate- | | | |
| | | | | | 3EO) | | | |
| 23 | 27-4-0 | 99 | | | Aerosol AOT-75 | 1 | Fish eyes & | Not suitable |
| | | | | | (sodium bis | | separate | |
| | | | | | (2-ethyl hexyl) | | | |
| | | | | | sulfosuccinate) | | | |

A review of table 10 reveals that it appears that in the same family of surfactants, the longer hydrocarbon chain length or higher ethoxylation disfavours solubility in concentrated fertilizer solutions. The surfactants suitable for 10-34-0 were always suitable for 27-4-0 fertilizer. However, some unsuitable surfactants for 10-34-0 may be suitable for 27-4-0 fertilizer.

Although Ethylan SN-50 and AOT-75 are well known surfactants that generally have excellent wetting ability, they were not suitable for the fertilizers tested.

### Example 9. Preparation of Imidacloprid Insecticide Suspensions in 10-34-0 Fertilizer Concentrates

Samples were prepared by combining 10-34-0 fertilizer, water and Witconate NAS-8 surfactant and thoroughly mixing. Then imidacloprid powder was added to the mixture and the final samples were mixed by hand-shaking. The amounts used are shown in table 8 below.

TABLE 11
Formulations for imidacloprid insecticide
suspensions in 10-34-0 fertilizer.

| Sample | A | B |
|---|---|---|
| 10-34-0 | 56.25 | 51.56 |
| Water | 18.75 | 17.19 |
| Witconate NAS-8 | 5 | 6.25 |
| Imidacloprid | 20 | 26.8 |
| −2 C. | Flowable | Flowable |
| Room temp | <10% top clear after | <10% top clear after |
| | 7 months. No crystal | 7 months. No crystal |
| | growth. Flows easily | growth. Flows easily. |
| 40 C. | 5-10% top clear after | ~5% top clear after |
| | 4 weeks. Easily re- | 4 weeks. Easily re- |
| | mixed to a homogenous | mixed to a homogenous |
| | product. No crystal | product. No crystal |
| | growth | growth |

A review of table 11 reveals that stable suspensions of imidacloprid insecticide in 10-34-0 fertilizer were prepared. These suspensions can be used alone, diluted with water, easily dispersed to a fertilizer concentrate including 10-34-0, 27-4-0, URAN 32, URAN 28, and 28-40% ammonium sulphate (AMS) without forming any nozzle blocking coarse particles.

### Example 10. Study of Imidacloprid Suspension Concentrates

Five samples were prepared by hand shaking in accordance with table 9 below. The samples were observed to compare the separation speed of the samples.

TABLE 12
Study of imidacloprid suspension concentrates.

| Sample | A | B | C | D | E |
|---|---|---|---|---|---|
| 10-34-0 | | | 72.7 | 56.25 | 41.72 |
| Water | 75 | 75 | | 18.75 | 31.57 |
| Witconate NAS-8 | 5 | | 5.1 | 5 | 4.45 |
| Phospholan PS-413 | | 5 | | | |
| Imidacloprid | 20 | 20 | 22.2 | 20 | 22.26 |
| Comment | Room temp 10 | Room temp 10 | Bottom | Room temp 7 | Room temp 7 |
| | minute >20% | minute ~10% | clear. Top | months <10% | months <10% |
| | top clear | top clear | very viscous | top clear. No | top clear. No |
| | | | | crystal growth | crystal growth |

In Sample A containing NAS-8 surfactant it was observed that the imidacloprid particles sank very quickly in water and they sank faster than the particle in sample B with PS-413 surfactant. Sample C showed that imidacloprid at 22.2% is lighter than 10-34-0 because the imidacloprid floated to the top. Samples D and E showed that the imidacloprid in diluted 10-34-0 fertilizer had a much slower sinking (settling) rate than in water (samples A and B) because the density difference between the imidacloprid and the diluted 10-34-0 was much smaller. This example showed that by changing the ratio of 10-34-0 to water, hence changing the density of the liquid medium, imidacloprid solid particles could be made to float or sink in the continuous medium.

Samples C, D and E can be used alone, diluted with water, easily dispersed to a fertilizer concentrate including 10-34-0, URAN 32, URAN 28 and 28-40% ammonium sulphate (AMS) without forming crystals or coagulation.

### Example 11. Preparation of Imidacloprid Insecticide Suspensions in 10-34-0 Fertilizer with Witconate AOS Surfactant

Samples were prepared by combining 10-34-0 fertilizer, water and Witconate AOS surfactant and thoroughly mixing. Then imidacloprid powder was added to the mixture and the final samples were homogenized. The amounts used are shown in table 11 below.

TABLE 13
Formulations for imidacloprid insecticide suspensions
in 10-34-0 fertilizer with Witconate AOS.

| Sample | A | B |
|---|---|---|
| 10-34-0 | 43.36 | 41.72 |
| Water | 21.64 | 31.57 |
| Witconate AOS | 5 | 4.45 |
| Imidacloprid | 30 | 22.26 |
| −2° C. | Flowable. <10% separation. | Flowable. <10% separation. |
| | No crystal growth. Stable | No crystal growth. Stable |
| Room temp | Good viscosity. <10% clear | Very stable. No crystal |
| | bottom phase after 1 month. | growth and no visible |
| | No crystal growth. Stable | separation after 1 |
| | | month. Stable |
| 40° C. | Turn into a paste after 2 | ~10% clear bottom phase |
| | days but became flowable | after 4 weeks. Can be re- |
| | again at room temp | mixed easily into a |
| | | homogeneous product at |
| | | room temperature. Stable |

A review of table 13 reveals that stable suspensions of imidacloprid insecticide in 10-34-0 fertilizer and Witconate AOS were prepared. The suspensions can be used alone, diluted with water, easily dispersed to a fertilizer concentrate including 10-34-0, URAN 32, URAN 28 and 28-40% ammonium sulfphate (AMS) without forming crystal and coagulation.

### Example 12. Preparation of 30 wt % Captan Fungicide Suspension in 10-34-0 Fertilizer

10-34-0 fertilizer (56% ammonium polyphosphate by Plant Food Company Inc.) and Phospholan PS-413 surfactant were combined in a container and mixed thoroughly. Captan fungicide was added to the mixture and then the resulting combination was homogenized. The components were added in amounts to provide a composition containing 69.3 wt % of the 10-34-0 fertilizer solution (56% solution), 1.0 wt % surfactant and 29.7 wt % Captan fungicide. The resulting suspension concentrate (SC) was easily flowable and stable. The SC was still able to flow at 2° C. After a week at 50° C. there was no visible phase separation. This suspension can be used alone, diluted with water, easily dispersed to a fertilizer concentrate including 10-34-0, URAN 32, URAN 28 and 28-40% ammonium sulfphate (AMS) without forming crystals or coagulation under gentle stirring.

### Example 13. Preparation of 37% Trifloxystrobin Fungicide in 10-34-0 Fertilizer

10-34-0 fertilizer (56% ammonium poly phosphate by Plant Food Company Inc.) and Phospholan HE-6614 surfactant were combined in a container and mixed thoroughly. Trifloxystrobin fungicide was added to the mixture and then the resulting combination was homogenized. The components were added in amounts to provide a composition containing 62.38 wt % of the 10-34-0 fertilizer solution (56% solution), 1.0 wt % surfactant and 36.63 wt % Trifloxystrobin fungicide. The resulting suspension concentrate (SC) was easily flowable and stable suspension concentrate (SC). The SC was still able to flow at 2° C. After a week at 50° C. less than 2.5% clear phase appeared at the bottom, but was remixed easily by inverting the container. This suspension can be used alone, diluted with water, easily dispersed to a fertilizer concentrate including 10-34-0, URAN 32, URAN 28 and 28-40% ammonium sulfphate (AMS) without forming crystal and coagulation.

### Comparative Example 1. Dispersing ARENA® 50 WDG Pesticide in 10-34-0 Fertilizer

As a comparative example, ARENA 50 WDG pesticide (a granulated product marketed by Valent U.S.A Corporation containing 50% clothianidin and other ingredients) was mixed with 10-34-0 fertilizer. It can be dispersed into water easily. However, it took a long time (>20 minutes with mixing) to fully disperse only a few percent of the granules into 10-34-0 fertilizer. In contrast, the pesticide suspension compositions of the present disclosure are dispersed completely with minimal mixing, as described above in the Examples.

1. A method for preparing a pesticide suspension concentrate (SC), said suspension comprising an aqueous fertilizer solution and a solid pesticide, said method comprising:
preparing at least two sample formulations with different fertilizer solution concentrations,
adding a first amount of solid pesticide to the sample formulations,
adding a first amount of wetting agent to the sample formulation,
gently mixing the sample formulations,
identifying a first sample formulation exhibiting floating solid pesticide,
identifying a second sample formulation exhibiting sinking solid pesticide,
preparing the pesticide suspension concentrate (SC) having a density between the first sample formulation and the second sample formulation, such that the pesticide suspension concentrate (SC) comprises an aqueous fertilizer density (D_{AF}) that matches the apparent density of the solid pesticide (D_{P}).

2. (canceled)

3. (canceled)

4. The method according to claim 1 wherein the wetting agent is screened for compatibility with the pesticide suspension concentrate (SC) by:
(i) adding 1 wt % of the wetting agent to the aqueous fertilizer solution and observing that the wetting agent is dispersed in the aqueous fertilizer solution,
(ii) adding the solution from (i) to the solid pesticide to confirm wettability.

5. The method according to claim 4 wherein the aqueous fertilizer solution comprises 1 wt % of dissolved wetting agent and exhibits a contact angle of <90° on a hydrophobic polyester surface.

6. A pesticide suspension concentrate (SC) comprising an aqueous fertilizer solution and a solid pesticide obtainable by the method of claim 1.

7. A pesticide suspension concentrate of claim 6 wherein the composition comprises from 5 to 70 wt % fertilizer based on the total composition, and wherein the pesticide lacks a carboxylate group.

8. The pesticide suspension concentrate according to claim 7, wherein the concentration of the fertilizer is in the range from 25 to 70 wt %, based on the total composition, and the concentration of the pesticide is in the range from 25 to 60 wt %, based on the weight of the total composition.

9. The pesticide suspension concentrate according to claim 6, wherein the fertilizer is chosen from 10-34-0, 27-4-0, URAN 32, URAN 28, 21-21-21, 13-27-27, 28-40% ammonium sulphate, and mixtures thereof.

10. (canceled)

11. The pesticide suspension concentrate according to claim 6, wherein the pesticide has a solubility of less than 1 wt % in the aqueous fertilizer solution.

12. The pesticide suspension concentrate according to claim 6, wherein the pesticide is chosen from clothianidin, imidacloprid, bifenthrin, trifloxystrobin, captan, myclobutanil, diuron, atrazine, and mixtures thereof.

13. The pesticide suspension concentrate according of claim 6, wherein the concentrate is substantially free from dispersants and suspension aids.

14. The pesticide suspension concentrate according to claim 6, wherein the pesticide composition further comprises one or more additives selected from dispersants, wetting agents, suspension aids and combination thereof, wherein the one or more additives are present in an amount of 10 wt % or less.

15. The pesticide suspension concentrate according to claim 6, wherein the concentrate composition does not contain an electrolyte water thickening polymer that results in a concentrate that displays shear thinning property and has a viscosity of less than 30000 mPa-s at 25° C. as measured by a Brookfield viscometer DV-II Pro with a spindle #64 at 60 RPM.

16. The pesticide suspension concentrate according to claim 6, wherein the pesticide suspension concentrate contains less than 1 wt % added anti-freeze agents.

17. The pesticide suspension concentrate according to claim 6 wherein said concentrate composition is substantially free of atrazine.

18. A method of seeding a field comprising applying a dose of a pesticide suspension concentrate according to claim 6 to soil close to or on top of a seed.

19. (canceled)

20. The pesticide suspension concentrate according to claim 6 wherein the wetting agent is a phosphate ester.

21. The pesticide suspension concentrate according to claim 6 comprising 40 wt % clothianidin solid pesticide and 60 wt % aqueous fertilizer solution, wherein the aqueous fertilizer solution comprises 78% 10-34-0 fertilizer and 22% URAN 32 fertilizer.

22. A pesticide suspension concentrate (SC) comprising an aqueous fertilizer solution and a solid pesticide, wherein the composition comprises about 5 to 70 wt % fertilizer, about 0.1 to 60 wt % pesticide, and about 1 to about 5 wt % wetting agent based on the total composition, wherein the pesticide is a non-dissociating compound, and wherein the composition has less than about 20% separation after 4-week storage at room temperature.
